(19) United States
(12) Patent Application Publication
(10) Pub. No.: US 2024/0323885 A1
(43) Pub. Date: Sep. 26, 2024

(54) METHOD AND APPARATUS FOR REPORTING TIMING ERROR

(71) Applicant: Beijing Xiaomi Mobile Software Co., Ltd., Beijing (CN)

(72) Inventor: Xuhua TAO, Beijing (CN)

(21) Appl. No.: 18/578,653

(22) PCT Filed: Jul. 14, 2021
(86) PCT No.: PCT/CN2021/106264

§ 371 Date: Jan. 11, 2024

(51) Int. Cl. H04W 56/00; H04W 64/00

(52) U.S. Cl. CPC H04W 56/0055; H04W 64/003

(57) ABSTRACT

A method for reporting a timing error is performed by a location management function (LMF) network element. The method includes: receiving first indication information transmitted by a transmission end, wherein the first indication information indicates timing error group (TEG) information of the transmission end, and the transmission end is a terminal device or a transmission and reception point (TRP).

### CROSS REFERENCE TO RELATED APPLICATIONS

The present application is a U.S. National Phase of International Application No. PCT/CN2021/106264, filed on Jul. 14, 2021, the content of which is incorporated herein by reference in its entirety.

### TECHNICAL FIELD

The present disclosure relates to the field of communication technology, and in particular, to a method and an apparatus for reporting a timing error.

### BACKGROUND

Generally, in a communication system, a time delay may exist in the process from generating a signal by a baseband processor to transmitting the signal by an antenna radio frequency port. Correspondingly, a time delay may also exist in the process from receiving a signal by an antenna radio frequency port to reaching a baseband processor by the signal.

### SUMMARY

According to a first aspect, there is provided a method for reporting a timing error according to embodiments of the present disclosure. The method is performed by a positioning management function (LMF) network element, and the method includes: receiving first indication information transmitted by a transmission end, where the first indication information indicates timing error group (TEG) information of the transmission end, and the transmission end is a terminal device or a transmission and reception point (TRP).

According to a second aspect, there is provided another method for reporting a timing error according to embodiments of the present disclosure. The method is performed by a terminal device, and the method includes: transmitting first indication information to a location management function (LMF) network element, where the first indication information indicates timing error group (TEG) information of the terminal device.

According to a third aspect, there is provided another method for reporting a timing error according to embodiments of the present disclosure. The method is performed by a transmission and reception point (TRP), and the method includes: transmitting first indication information, where the first indication information indicates timing error group (TEG) information of the TRP.

### BRIEF DESCRIPTION OF THE DRAWINGS

In order to more clearly illustrate the technical solutions in the embodiments of the present disclosure or the background, the drawings that need to be used in the embodiments of the present disclosure or the background are described below.

FIG. 1 is a schematic architectural diagram of a communication system according to some embodiments of the present disclosure;

FIG. 2 is a schematic flowchart of a method for reporting a timing error according to some embodiments of the present disclosure;

FIG. 3 is a schematic flowchart of a method for reporting a timing error according to some embodiments of the present disclosure;

FIG. 4 is a schematic flowchart of a method for reporting a timing error according to some embodiments of the present disclosure;

FIG. 5 is a schematic flowchart of a method for reporting a timing error according to some embodiments of the present disclosure;

FIG. 6 is a schematic flowchart of a method for reporting a timing error according to some embodiments of the present disclosure;

FIG. 7 is a schematic flowchart of a method for reporting a timing error according to some embodiments of the present disclosure;

FIG. 8 is a schematic flowchart of a method for reporting a timing error according to some embodiments of the present disclosure;

FIG. 9 is a schematic flowchart of a method for reporting a timing error according to some embodiments of the present disclosure;

FIG. 10 is a schematic structural diagram of a communication apparatus according to some embodiments of the present disclosure;

FIG. 11 is a schematic structural diagram of a communication apparatus according to some embodiments of the present disclosure;

FIG. 12 is a schematic structural diagram of a chip according to some embodiments of the present disclosure.

### DETAILED DESCRIPTION

In order to better understand the method for reporting a timing error disclosed in the embodiments of the present disclosure, a communication system applicable to the embodiments of the present disclosure is firstly described below.

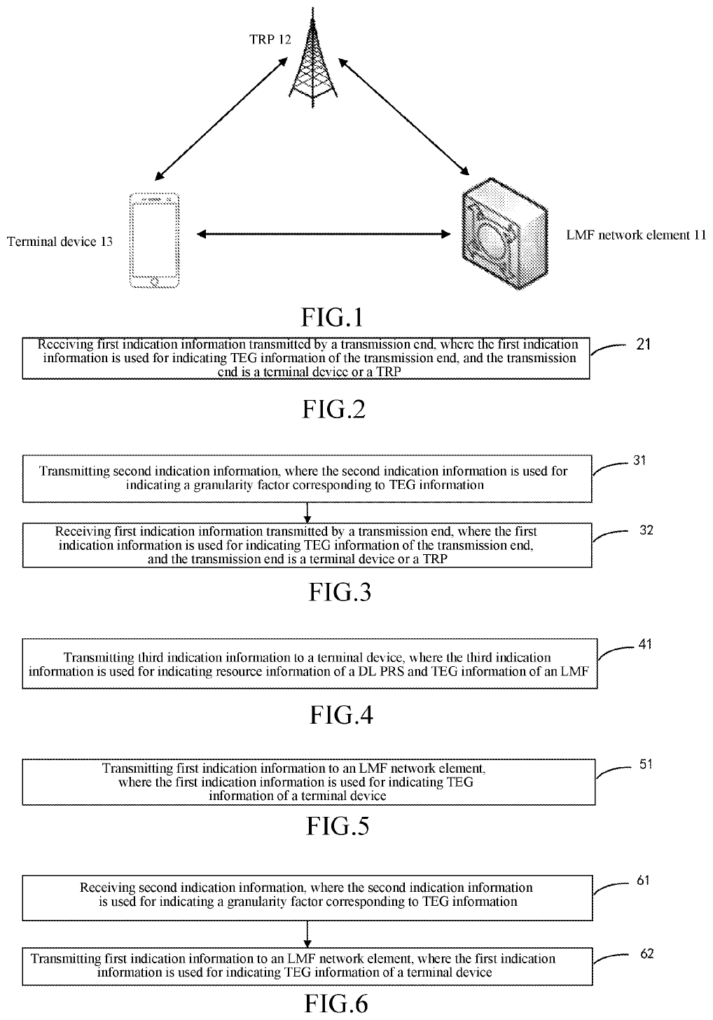

Referring to FIG. 1, FIG. 1 is a schematic architectural diagram of a communication system according to some embodiments of the present disclosure. The communication system may include, but is not limited to, a location management function (LMF) network element, a terminal device, and a transmission and reception point (TRP). The number and form of devices shown in FIG. 1 are for examples and do not constitute a limitation on the embodiments of the present disclosure. Two or more LMF network elements, two or more terminal devices, two or more TRPs may be included in the actual application. The communications system shown in FIG. 1 takes that an LMF network element 11, a TRP 12, and a terminal device 13 are included as an example.

It should be noted that the technical solutions of the embodiments of the present disclosure may be applied to various communication systems, such as, a long term evolution (LTE) system, a fifth generation (5G) mobile communication system, a 5G new radio (NR) system, or other future novel mobile communication systems, etc.

The LMF network element 11 in the embodiments of the present disclosure may be responsible for selecting a positioning method and triggering a corresponding positioning measurement, and may calculate a final positioning result and accuracy.

The TRP 12 in the embodiments of the present disclosure is an entity on a network side for transmitting or receiving a signal. For example, TRP 12 may be an evolved NodeB (eNB), a next generation NodeB (gNB) in an NR system, a base station in other future mobile communication systems, or an access node in a wireless fidelity (WiFi) system. The embodiments of the present disclosure do not limit the specific technology and the specific device form adopted by the transmission and reception point. The TRP 12 provided in the embodiments of the present disclosure may be composed of a central unit (CU) and a distributed unit (DU), where the CU may also be referred to as a control unit. By adopting the CU-DU structure, the protocol layers of the transmission and reception point, such as the base station, may be split. Functions of some of the protocol layers are centrally controlled in the CU; and, functions of the remaining part or all of the protocol layers are distributed in the DU, and the DU is centrally controlled by the CU.

The terminal device 13 in the embodiments of the present disclosure is an entity on a user side, such as a mobile phone, for receiving or transmitting a signal. The terminal device may also be referred to as a terminal, a user equipment (UE), a mobile station (MS), a mobile terminal (MT), etc. The terminal device may be an automobile having a communication function, a smart car, a mobile phone, a wearable device, a tablet computer (PAD), a computer with a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, or the like. The embodiments of the present disclosure do not limit the specific technology and the specific device form used by the terminal device.

It can be understood that the communication system described in the embodiments of the present disclosure is for describing the technical solutions of the embodiments of the present disclosure more clearly, and does not constitute a limitation on the technical solutions provided in the embodiments of the present disclosure. Those of ordinary skills in the art may know that, with the evolution of the system architecture and the occurrence of a new service scenario, the technical solutions provided in the embodiments of the present disclosure are also applicable to similar technical problems.

The method and apparatus for reporting a timing error provided by the present disclosure will be described in detail below with reference to the accompanying drawings.

Referring to FIG. 2, FIG. 2 is a schematic flowchart of a method for reporting a timing error according to some embodiments of the present disclosure, and the method is performed by an LMF network element. As shown in FIG. 2, the method may include, but is not limited to, the following steps.

In step 21, first indication information transmitted by a transmission end is received, where the first indication information is used for indicating timing error group information of the transmission end, and the transmission end is a terminal device or a transmitting reception point.

Generally, in a communication system, a time delay may exist in in the process from generating a signal by a baseband processor to transmitting the signal by an antenna radio frequency port. Correspondingly, a time delay may also exist in the process from receiving a signal by an antenna radio frequency port to reaching a baseband processor by the signal. The above time delay is commonly referred to as timing error group (TEG). In the positioning process, the above-mentioned time delay can affect the positioning performance. Therefore, how to improve the positioning accuracy becomes a problem to be solved urgently.

In a related positioning method, for example, in an observed time difference of arrival (OTDOA) method, the terminal device is positioned according to the time difference of the signal propagation between three base stations and the terminal device. Among them, the time difference of the signal propagation between the base station and the terminal device includes a timing error corresponding to the terminal device and a timing error corresponding to the base station. In the present disclosure, the terminal device or the transmission and reception point (TRP) may transmit its corresponding TEG information to the LMF network element, so that the LMF network element can remove the influence caused by the TEG information in the process of positioning the terminal device, so as to improve the accuracy and precision of positioning.

In the embodiments of the present disclosure, the LMF network element may receive the timing error group (TEG) information transmitted by the terminal device, so as to obtain the TEG information of the terminal device. Then, the LMF network element may position the terminal device according to the TEG information of the terminal device, thus reducing the positioning error as much as possible and improving the positioning accuracy. Alternatively, the LMF network element may also receive the TEG information of the transmission and reception point (TRP), so as to obtain the TEG information of the TRP. Then, the LMF network element may position the terminal device according to the TEG information of the TRP, thus reducing the positioning error as much as possible and improving the positioning accuracy.

In some embodiments, the TEG information may be a TEG value, or may be a TEG identification; Alternatively, it may also be a TEG value and a TEG identification, or the like, which is not limited in the present disclosure.

Among them, the style or presentation form of the TEG identification may be any form agreed upon in the protocol; for example, it may be TEG_0, TEG_1, or the like, which is not limited in the present disclosure.

By implementing the embodiments of the present disclosure, the LMF network element may receive the first indication information transmitted by the terminal device or the TRP, so as to obtain the TEG information of the terminal device or the TEG information of the TRP; and then, the LMF network element may position the terminal device based on the TEG information of the terminal device or the TEG information of the TRP, thus reducing the positioning error as much as possible and improving the positioning accuracy.

Referring to FIG. 3, FIG. 3 is a schematic flowchart of a method for reporting a timing error according to some embodiments of the present disclosure, and the method is performed by an LMF network element. As shown in FIG. 3, the method may include, but is not limited to, the following steps.

In step 31, second indication information is transmitted, where the second indication information is used for indicating a granularity factor corresponding to the TEG information.

Among them, The LMF network element may transmit the second indication information to the terminal device, so that the terminal device may determine corresponding TEG information according to the received granularity factor; or, the LMF network element may also transmit the second indication information to the TRP, so that the TRP may determine corresponding TEG information according to the received granularity factor.

In some embodiments, the LMF network element may determine a granularity factor corresponding to the TEG information according to the current positioning accuracy.

For example, the higher the current positioning accuracy, the smaller the granularity factor corresponding to the TEG information; and, the lower the current positioning accuracy, the greater the granularity factor corresponding to the TEG information.

Alternatively, the corresponding relationship between the positioning accuracy and the granularity factor may also be agreed upon in the protocol. Therefore, the LMF network element may determine the granularity factor corresponding to the TEG information according to the current positioning accuracy and the corresponding relationship between the positioning accuracy and the granularity factor.

It should be noted that the above examples are illustrative and cannot be used as a limitation on the manner for determining the granularity factor corresponding to the TEG information in the embodiments of the present disclosure.

In some embodiments, the LMF network element may also determine the granularity factor corresponding to the TEG information according to a value range of the granularity factor corresponding to each subcarrier spacing (SCS).

For example, the value range of the granularity factor corresponding to each subcarrier spacing (SCS) may be agreed upon in the protocol. Therefore, the LMF network element may determine, according to the current subcarrier spacing, the value range of the granularity factor corresponding to the current subcarrier spacing, and select any numerical value from the value range of the granularity factor as the value of the granularity factor, which is not limited in the present disclosure.

In some embodiments, the second indication information may be request location information.

Therefore, in the embodiments of the present disclosure, the LMF network element may indicate the granularity factor corresponding to the TEG information to the terminal device or the TRP through transmitting the request location information.

For example, it may be agreed upon in the protocol that a specific bit is added to the request location information, and the granularity factor is represented by a value of the specific bit. Therefore, after receiving the request location information, the terminal device or the TRP may determine the corresponding granularity factor or the like according to the value of the specific bit, which is not limited in the present disclosure.

In step 32, first indication information transmitted by a transmission end is received, where the first indication information is used for indicating TEG information of the transmission end, and the transmission end is a terminal device or a TRP.

In some embodiments, the first indication information may be further used for indicating resource information of a downlink (DL) positioning reference signal (PRS), or may be further used for indicating reference signal time difference (RSTD) measurement information.

Among them, the resource information of the DL PRS may be time domain resource information of the DL PRS, or may also be frequency domain resource information of the DL PRS, or may also be time domain and frequency domain resource information of the DL PRS, or the like, which is not limited in the present disclosure.

In addition, the RSTD measurement information may include a timing error of a transmission end, or may also include a timing error of a reception end, or the like, which is not limited in the present disclosure.

In some embodiments, the LMF network element may obtain TEG information of the TRP and resource information of the DL PRS according to the received first indication information transmitted by the TRP, and position the terminal device according to the TEG information and the resource information of the DL PRS, thus reducing the positioning error as much as possible and improving the positioning accuracy.

Alternatively, the LMF network element may also obtain TEG information and RSTD measurement information of the terminal device according to the received first indication information transmitted by the terminal device, process the RSTD measurement information according to the TEG information, and then position the terminal device, thus reducing the positioning error as much as possible and improving the positioning accuracy.

In some embodiments, the TEG information may be a TEG value and/or a TEG identification, the specific content and implementation manner of which may refer to the description of other embodiments of the present disclosure, and details are not described here again.

By implementing the embodiments of the present disclosure, the LMF network element may transmit the second indication information so as to indicate the granularity factor corresponding to the TEG information to the transmission end, and then may obtain the TEG information of the transmission end according to the received first indication information transmitted by the transmission end, and then may position the terminal device according to the TEG information of the transmission end, thus reducing the positioning error as much as possible and improving the positioning accuracy.

Referring to FIG. 4, FIG. 4 is a schematic flowchart of a method for reporting a timing error according to some embodiments of the present disclosure, and the method is performed by an LMF network element. As shown in FIG. 4, the method may include, but is not limited to, the following steps.

In step 41, third indication information is transmitted to the terminal device, where the third indication information is used for indicating the resource information of the DL PRS and the TEG information of the LMF.

In the embodiments of the present disclosure, the LMF network element may transmit the third indication information to the terminal device, so that the terminal device may obtain the resource information of the DL PRS and the TEG information of the LMF, and perform positioning according to the resource information of the DL PRS and the TEG information of the LMF, thus reducing the positioning error and improving the positioning accuracy.

By implementing the embodiments of the present disclosure, the LMF network element may indicate the resource information of the DL PRS and the TEG information of the LMF to the terminal device, so that the terminal device performs positioning according to the resource information of the DL PRS and the TEG information of the LME Therefore, the influence of TEG information on positioning is avoided, thus reducing the positioning error and improving the positioning accuracy.

In some embodiments of the present disclosure, the TEG information may be a TEG value and/or a TEG identification, the specific content and implementation manner of which may refer to the description of other embodiments of the present disclosure, and details are not described here again.

For example, Tc is a time unit, the value range of TEG may be [−x, y] *Tc, and the size of the granularity may be 2 k*Tc. For example, the value of k is −1, and the mapping relationship between the identification and the value of TEG may be as shown in Table 1 below.

TABLE 1

| TEG identification | TEG value | Time unit |
|---|---|---|
| TEG_0 | TEG < −x | Tc |
| TEG_1 | −x ≤ TEG < −x + 0.5 | Tc |
| TEG_2 | −x + 0.5 ≤ TEG < −x + 1 | Tc |
| . . . | . . . | Tc |
| TEG_x + y | y − 0.5 ≤ TEG < y | Tc |
| TEG_x + y + 1 | y ≤ TEG | Tc |

For example, in the case that the granularity factor is −1, if the LMF network element determines that the TEG value satisfies −x≤TEG<−x+0.5, the LMF network element may determine the current TEG identification as TEG_1. Then, the LMF network element may transmit third indication information to the terminal device, so that the terminal device may obtain the resource information of the DL PRS and the TEG identification of the LMF network element as TEG_1. Therefore, when performing positioning, the terminal device may remove the influence of the TEG of the LMF network element on the positioning result, thus reducing the positioning error as much as possible and improving the positioning accuracy.

It should be noted that the above examples are illustrative, and cannot be used as a limitation on the value of the granularity factor, the value and the identification of the TEG, or the like, in the embodiments of the present disclosure.

It is to be understood that each element in Table 1 is independently present. These elements are listed in the same table as examples, but it does not represent that all elements in the table must be present simultaneously as shown in the table. Among them, the value of each element is not dependent on the value of any other element in Table 1. Therefore, it may be understood by those skilled in the art that the value of each element in Table 1 is an independent embodiment.

Referring to FIG. 5, FIG. 5 is a schematic flowchart of a method for reporting a timing error according to some embodiments of the present disclosure, and the method is performed by a terminal device. As shown in FIG. 5, the method may include, but is not limited to, the following steps.

In step 51, first indication information is transmitted to an LMF network element, where the first indication information is used for indicating TEG information of the terminal device.

In the embodiments of the present disclosure, the terminal device may transmit the first indication information to the LMF network element, so that the LMF network element may obtain the TEG information of the terminal device, and then remove the influence caused by the TEG when positioning the terminal device, thus improving the positioning accuracy and precision.

In some embodiments, the TEG information may be a TEG value, or may be a TEG identification. Alternatively, it may also be a TEG value, a TEG identification, or the like, which is not limited in the present disclosure.

Among them, the style or presentation form of the TEG identification may be any form agreed upon in the protocol; for example, it may be TEG_0, TEG_1, or the like, which is not limited in the present disclosure.

By implementing the embodiments of the present disclosure, the terminal device may transmit the first indication information to the LMF network element, so that the LMF network element may obtain the TEG information of the terminal device. Therefore, the LMF network element may remove the influence caused by the TEG information when positioning the terminal device, thus reducing the positioning error as much as possible and improving the positioning accuracy and precision.

Referring to FIG. 6, FIG. 6 is a schematic flowchart of a method for reporting a timing error according to some embodiments of the present disclosure, and the method is performed by a terminal device. As shown in FIG. 6, the method may include, but is not limited to, the following steps.

In step 61, second indication information is received, where the second indication information is used for indicating a granularity factor corresponding to the TEG information.

In the embodiments of the present disclosure, the terminal device may determine the granularity factor corresponding to the TEG information according to the received second indication information, and then determine the TEG value corresponding to the granularity factor.

In some embodiments, the TEG information may be a TEG value, or may be a TEG identification. Alternatively, it may also be a TEG value, a TEG identification, or the like, which is not limited in the present disclosure.

For example, the corresponding relationship between the TEG value and the TEG identification may be agreed upon in the protocol.

For example, according to the received second indication information, the terminal device obtains that the granularity factor corresponding to the TEG information is −1, then may determine the corresponding TEG value when the granularity factor is −1, and then may determine the TEG identification or the like, according to the corresponding relationship between the TEG value and the TEG identification, which is not limited in the present disclosure.

In step 62, first indication information is transmitted to the LMF network element, where the first indication information is used for indicating TEG information of the terminal device.

Among them, the terminal device may first determine the TEG information corresponding to the granularity factor according to the received granularity factor corresponding to the TEG information, and then may transmit the first indication information to the LMF network element, so that the LMF network element may obtain the TEG information of the terminal device. Therefore, the LMF network element may remove the influence caused by the TEG information when positioning the terminal device, thus improving the positioning accuracy.

By implementing the embodiments of the present disclosure, the terminal device can determine the TEG information corresponding to the granularity factor according to the received second indication information, and then can transmit the first indication information to the LMF network element, so that the LMF network element can obtain the TEG information of the terminal device. Therefore, the LMF network element can position the terminal device based on the TEG information of the terminal device, thus reducing the positioning error as much as possible and improving the positioning accuracy.

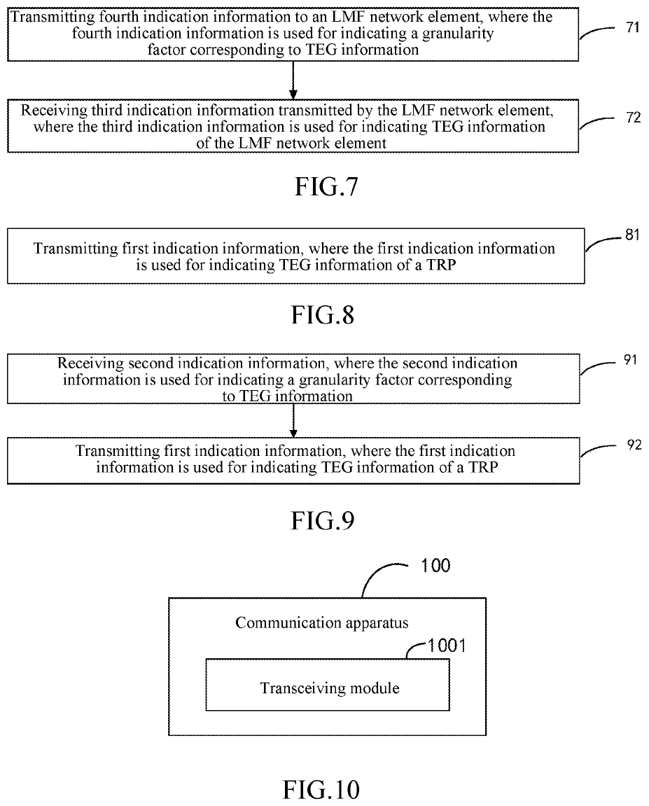

Referring to FIG. 7, FIG. 7 is a schematic flowchart of a method for reporting a timing error according to some embodiments of the present disclosure, and the method is performed by a terminal device. As shown in FIG. 7, the method may include, but is not limited to, the following steps.

In step 71, fourth indication information is transmitted to the LMF network element, where the fourth indication information is used for indicating a granularity factor corresponding to the TEG information.

Among them, the terminal device may transmit the fourth indication information to the LMF network element, so that the LMF network element may determine corresponding TEG information according to the received granularity factor.

In some embodiments, the terminal device may determine the granularity factor corresponding to the TEG information according to the current positioning accuracy.

For example, the higher the current positioning accuracy, the smaller the granularity factor corresponding to the TEG information; and, the lower the current positioning accuracy, the greater the granularity factor corresponding to the TEG information.

Alternatively, the corresponding relationship between the positioning accuracy and the granularity factor may also be agreed upon in the protocol. Therefore, the LMF network element may determine the granularity factor corresponding to the TEG information according to the current positioning accuracy.

It should be noted that the above examples are illustrative and cannot be used as a limitation on the manner for determining the granularity factor corresponding to the TEG information in the embodiments of the present disclosure.

In some embodiments, the terminal device may also determine the granularity factor corresponding to the TEG information according to a value range of the granularity factor corresponding to each subcarrier spacing (SCS).

For example, protocol agreement may be performed, and the value range of the granularity factor corresponding to each subcarrier spacing SCS is within the range of the value of the granularity factor corresponding to each subcarrier spacing SCS. Therefore, the terminal device can determine the value range of the granularity factor corresponding to the terminal device according to the current subcarrier spacing, and then select any numerical value as the value of the granularity factor from the range of the granularity factor value, which is not limited in the present disclosure.

In step 72, third indication information transmitted by the LMF network element is received, where the third indication information is used for indicating the TEG information of the LMF network element.

For example, it may be agreed upon in the protocol that a value of a specific bit in the third indication information may represent the TEG information. Then, the terminal device may obtain the TEG information of the LMF network element according to the value of the specific bit in the third indication information, so that the terminal device may remove the influence caused by the TEG information of the LMF network element when performing positioning, thus improving the positioning accuracy and precision.

By implementing the embodiments of the present disclosure, the terminal device may transmit the fourth indication information, so that the LMF network element obtains the granularity factor corresponding to the TEG information; and then, the terminal device may receive the third indication information transmitted by the LMF network element to obtain the TEG information of the LMF network element. Therefore, during the positioning process of the terminal device, the influence of the TEG information of the LMF network element on the positioning is avoided, thus reducing the positioning error and improving the positioning accuracy.

Referring to FIG. 8, FIG. 8 is a schematic flowchart of a method for reporting a timing error according to some embodiments of the present disclosure, and the method is performed by a TRP. As shown in FIG. 8, the method may include, but is not limited to, the following steps.

In step 81, first indication information is transmitted, where the first indication information is used for indicating TEG information of the TRP.

In the embodiments of the present disclosure, the TRP may transmit the first indication information, so that the LMF network element obtains the TEG information of the TRP.

Therefore, the LMF network element may remove the influence caused by the TEG information when positioning the terminal device based on the TEG information of the TRP, thus improving the positioning accuracy and precision.

In some embodiments, the TEG information may be a TEG value, or may be a TEG identification. Alternatively, it may also be a TEG value, a TEG identification, or the like, which is not limited in the present disclosure.

Among them, the style or presentation form of the TEG identification may be any form agreed upon in the protocol; for example, it may be TEG_0, TEG_1, or the like, which is not limited in the present disclosure.

By implementing the embodiments of the present disclosure, the TRP may transmit the first indication information to the LMF network element, so that the LMF network element obtains the TEG information of the TRP. Therefore, the LMF network element may position the terminal device based on the TEG information of the TRP, thus reducing the positioning error as much as possible and improving the positioning accuracy.

Referring to FIG. 9, FIG. 9 is a schematic flowchart of a method for reporting a timing error according to some embodiments of the present disclosure, and the method is performed by a TRP. As shown in FIG. 9, the method may include, but is not limited to, the following steps.

In step 91, second indication information is received, where the second indication information is used for indicating a granularity factor corresponding to the TEG information.

For example, according to the received second indication information, the TRP obtains that the granularity factor corresponding to the TEG information is −1, then may determine the corresponding TEG value when the granularity factor is −1, and then may determine the TEG identification or the like, according to the corresponding relationship between the TEG value and the TEG identification, which is not limited in the present disclosure.

In some embodiments, the second indication information may be request location information.

For example, it may be agreed upon in the protocol that a specific bit is added to the request location information, and the granularity factor is represented by a value of the specific bit. Therefore, after receiving the request location information, the TRP may determine the corresponding granularity factor according to the value of the specific bit, and then may determine the corresponding TEG value and the TEG identification, or the like, which is not limited in the present disclosure.

In step 92, first indication information is transmitted, where the first indication information is used for indicating TEG information of the TRP.

In some embodiments, the first indication information may further be used for indicating resource information of the DL PRS.

Among them, the resource information of the DL PRS may be time domain resource information of the DL PRS, or may also be frequency domain resource information of the DL PRS, or may also be time domain and frequency domain resource information of the DL PRS, or the like, which is not limited in the present disclosure.

Therefore, in the embodiments of the present disclosure, the TRP may transmit the first indication information to the LMF network element, so that the LMF network element may obtain the TEG information of the TRP and the resource information of the DL PRS, and position the terminal device based on the TEG information and the resource information of the DL PRS, thus reducing the positioning error as much as possible, and improving the positioning accuracy.

In some embodiments, the first indication information may be signal measurement information.

Therefore, in the embodiments of the present disclosure, the TRP may transmit the signal measurement information so as to indicate the TEG information of the TRP to the LMF network element.

For example, it may be agreed upon in the protocol that a specific bit is added to the signal measurement information, and the TEG information is represented according to a value of the specific bit. Therefore, after receiving the signal measurement information transmitted by the TRP, the LMF network element may determine the TEG information of the TRP according to the value of the specific bit, or the like, which is not limited in the present disclosure.

By implementing the embodiments of the present disclosure, the TRP may receive the second indication information to obtain the granularity factor corresponding to the TEG information, and then may transmit the first indication information, so that the LMF network element may obtain the TEG information of the TRP. Therefore, the LMF network element may remove the influence caused by the TEG information when positioning the terminal device, thus reducing the positioning error and improving the positioning accuracy.

In the embodiments provided in the present disclosure, the method provided by the embodiments of the present disclosure is described from the perspective of the LMF network element, the terminal device, and the TRP, respectively. In order to implement the various functions in the method provided in the embodiments of the present disclosure, the LMF network element, the terminal device, or the TRP may include a hardware structure and a software module to implement the foregoing various functions in the form of a hardware structure, a software module, or a hardware structure plus a software module. Some of the foregoing various functions may be performed in the manner of a hardware structure, a software module, or a hardware structure plus a software module.

Referring to FIG. 10, it is a schematic structural diagram of a communication apparatus 100 according to some embodiments of the present disclosure. The communication apparatus 100 shown in FIG. 10 may include a transceiving module 1001.

The transceiving module 1001 may include a transmitting module and/or a receiving module, the transmitting module is configured to implement a transmitting function, the receiving module is configured to implement a receiving function, and the transceiving module 1001 may implement a transmitting function and/or a receiving function.

It may be understood that the communication apparatus 100 may be an LMF network element, or may be an apparatus in an LMF network element, or may be an apparatus that can be used in matching with an LMF network element.

The communication apparatus 100 is configured on the side of an LMF network element, and includes a transceiving module 1001.

The transceiving module 1001 is configured to receive first indication information transmitted by a transmission end, where the first indication information is used for indicating timing error group (TEG) information of the transmission end, and the transmission end is a terminal device or a transmission and reception point (TRP).

In some embodiments, the first indication information is further used for indicating any one of the following: resource information of a downlink (DL) positioning reference signal (PRS), or reference signal time difference (RSTD) measurement information.

In some embodiments, the first indication information is signal measurement information.

In some embodiments, the transceiving module 1001 is further configured to transmit second indication information, where the second indication information is used for indicating a granularity factor corresponding to the TEG information.

In some embodiments, the second indication information is request location information.

In some embodiments, the communication apparatus further includes a processing module, configured to:
determine the granularity factor corresponding to the TEG information according to a current positioning accuracy;
or
determine the granularity factor corresponding to the TEG information according to a value range of the granularity factor corresponding to each subcarrier spacing (SCS).

In some embodiments, the transceiving module 1001 is further configured to transmit third indication information to the terminal device, where the third indication information is used for indicating resource information of the downlink (DL) positioning reference signal (PRS) and TEG information of the LMF.

In some embodiments, the TEG information is a TEG value and/or a TEG identification.

According to the communication apparatus provided by the embodiments of the present disclosure, the LMF network element may receive the first indication information transmitted by the terminal device or the TRP, so as to obtain TEG information of the terminal device or TEG information of the TRP, and then may position the terminal device based on the TEG information of the terminal device or the TEG information of the TRP, thus reducing the positioning error as much as possible and improving the positioning accuracy.

It may be understood that the communication apparatus 100 may be a terminal device, or may be an apparatus in a terminal device, or may be an apparatus that can be used in matching with a terminal device.

The communication apparatus 100 is configured on the side of a terminal device, and includes a transceiving module 1001.

The transceiving module 1001 is configured to transmit first indication information to a location management function (LMF) network element, where the first indication information is used for indicating timing error group (TEG) information of the terminal device.

In some embodiments, the first indication information is further used for indicating reference signal time difference (RSTD) measurement information.

In some embodiments, the first indication information is signal measurement information.

In some embodiments, the transceiving module 1001 is further configured to receive second indication information, where the second indication information is used for indicating a granularity factor corresponding to the TEG information.

In some embodiments, the transceiving module 1001 is further configured to receive third indication information transmitted by the LMF, where the third indication information is used for indicating TEG information of the LMF.

In some embodiments, the transceiving module 1001 is further configured to transmit fourth indication information to the LMF, where the fourth indication information is used for indicating a granularity factor corresponding to the TEG information.

In some embodiments, the communication apparatus further includes a processing module, configured to:
determine the granularity factor corresponding to the TEG information according to a current positioning accuracy;
or
determine the granularity factor corresponding to the TEG information according to a value range of the granularity factor corresponding to each subcarrier spacing (SCS).

In some embodiments, the fourth indication information is request location information.

In some embodiments, the TEG information is a TEG value and/or a TEG identification.

According to the communication apparatus provided by the embodiments of the present disclosure, the terminal device can transmit the first indication information to the LMF network element, so that the LMF network element can obtain the TEG information of the terminal device, and the LMF network element can remove the influence caused by the TEG when positioning the terminal device, thus reducing the positioning error as much as possible and improving the positioning accuracy and precision.

It may be understood that the communication apparatus 100 may be a TRP, or may be an apparatus in a TRP, or may be an apparatus that can be used in matching with a TRP.

The transceiving module 1001 is configured to transmit first indication information, where the first indication information is used for indicating timing error group (TEG) information of the TRP.

In some embodiments, the first indication information is further configured to indicate resource information of the downlink (DL) positioning reference signal (PRS).

In some embodiments, the first indication information is signal measurement information.

In some embodiments, the transceiving module 1001 is further configured to receive second indication information, where the second indication information is used for indicating a granularity factor corresponding to the TEG information.

In some embodiments, the second indication information is request location information.

In some embodiments, the TEG information is a TEG value and/or a TEG identification.

According to the communication apparatus provided in the embodiments of the present disclosure, the TRP may transmit first indication information to the LMF network element, so that the LMF network element can obtain the TEG information of the TRP, and the LMF network element can position the terminal device based on the TEG information of the TRP, thus reducing the positioning error as much as possible and improving the positioning accuracy.

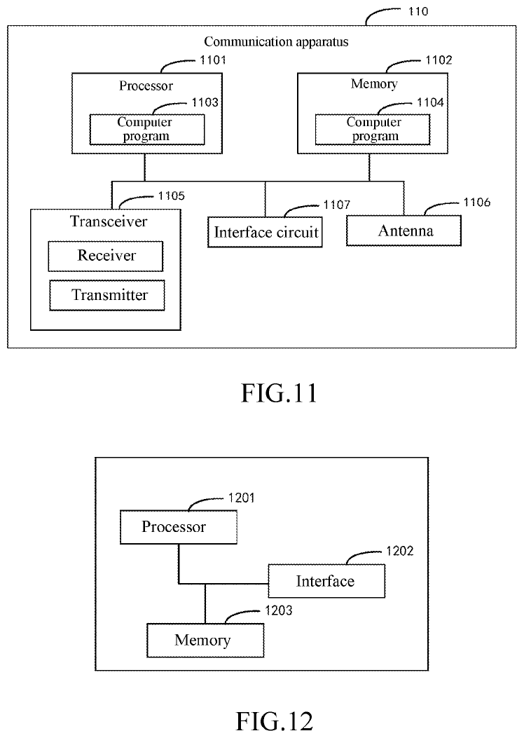

Referring to FIG. 11, FIG. 11 is a schematic structural diagram of another communication apparatus 110 according to some embodiments of the present disclosure. The communication apparatus 110 may be an LMF network element; or, it may be a terminal device; or, it may be a TRP; or, it may be a chip, a chip system, or a processor that supports an LMF network element to implement the foregoing method; it may also be a chip, a chip system, or a processor that supports a terminal device to implement the foregoing method; it may also be a chip, a chip system, or a processor that supports a TRP to implement the foregoing method. The communication apparatus may be used to implement the method described in the foregoing method embodiments, and may refer to the description in the foregoing method embodiments.

The communication apparatus 110 may include one or more processors 1101, and the processor 1101 may be a general-purpose processor or a dedicated processor. For example, it may be a baseband processor or a central processing unit. The baseband processor may be configured to process a communication protocol and communication data, and the central processing unit may be configured to control a communication apparatus (such as a base station, a baseband chip, a terminal device, a terminal device chip, a DU, or a CU), execute a computer program, and process data of the computer program.

In some embodiments, the communication apparatus 110 may further include one or more memories 1102 on which a computer program 1104 may be stored. The processor 1101 executes the computer program 1104, so that the communication apparatus 110 performs the method described in the foregoing method embodiments. In some embodiments, the memory 1102 may further store data. The communication apparatus 110 and the memory 1102 may be separately disposed, or may be integrated together.

In some embodiments, the communication apparatus 110 may further include a transceiver 1105, and an antenna 1106. The transceiver 1105 may be referred to as a transceiving unit, a transceiver, or a transceiving circuit, for implementing a transceiver function. The transceiver 1105 may include a receiver and a transmitter. The receiver may be referred to as a receiving equipment or a receiving circuit, for implementing a receiving function; and the transmitter may be referred to as a transmitting equipment or a transmitting circuit, for implementing a transmitting function.

In some embodiments, the communication apparatus 110 may further include one or more interface circuits 1107 configured to receive code instructions and transmit the code instructions to the processor 1101. The processor 1101 runs the code instructions to enable the communication apparatus 110 to perform the method described in the foregoing method embodiments.

The communication apparatus 110 is an LMF network element. The transceiver 1105 is configured to perform step 21 in FIG. 2, step 31 in FIG. 3, step 32 in FIG. 3, or step 41 in FIG. 4

The communication apparatus 110 is a terminal device. The transceiver 1105 is configured to perform step 55 in FIG. 5, step 61 in FIG. 6, step 62 in FIG. 6, step 71 in FIG. 7, or step 72 in FIG. 7.

The communication device 110 is a TRP The transceiver 1105 is configured to perform step 81 in FIG. 8, step 91 in FIG. 9, or step 92 in FIG. 9.

In some embodiments, the processor 1101 may include a transceiver for implementing a receiving and transmitting function. For example, the transceiver may be a transceiving circuit, an interface, or an interface circuit. The transceiving circuit, the interface, or the interface circuit for implementing the receiving and transmitting function may be separate or integrated together. The transceiving circuit, the interface, or the interface circuit may be configured for reading and writing of codes/data; or, the transceiving circuit, the interface, or the interface circuit may be configured for transmission or delivery of signals.

In some embodiments, the processor 1101 may store a computer program 1103, and the computer program 1103 runs on the processor 1101, so that the communication apparatus 110 may perform the method described in the foregoing method embodiments. The computer program 1103 may be cured in the processor 1101; and, in this case, the processor 1101 may be implemented by hardware.

In some embodiments, the communication apparatus 110 may include a circuit, and the circuit may implement a function of transmitting or receiving or communicating in the foregoing method embodiments. The processor and the transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), or an electronic device, etc. The processor and the transceiver may also be manufactured using various IC process technologies, such as complementary metal oxide semiconductor (CMOS), nMetal oxide-semiconductor (NMOS), positive channel metal oxide semiconductor (PMOS), bipolar junction transistor (BJT), bipolar CMOS (BiCMOS) Silicon Germanium (SiGe), Gallium Arsenide (GaAs), etc.

The communication apparatus described in the above embodiments may be an LMF network element, a terminal device, or a TRP, but the scope of the communication apparatus described in the present disclosure is not limited to these, and the structure of the communication apparatus may not be limited by FIG. 11. The communication apparatus may be a independent device or may be a part of a greater device. For example, the communication apparatus may be:
(1) an independent integrated circuit (IC), a chip, or a chip system or subsystem;
(2) a set having one or more ICs; in some embodiments, the IC set may also include a storage component for storing data and a computer program;
(3) an ASIC, such as a modem;
(4) a module that may be embedded in other devices;
(5) a receiver, a terminal device, an intelligent terminal device, a cellular phone, a wireless device, a handset, a mobile unit, a vehicle-mounted device, a network device, a cloud device, an artificial intelligence device, etc.;
(6) others.

For the case that the communication apparatus may be a chip or a chip system, it may refer to the schematic structural diagram of a chip shown in FIG. 12. The chip shown in FIG. 12 includes a processor 1201 and an interface 1202, where the number of the processor 1201 may be one or more, and the number of the interface 1202 may be more than one.

For the case that the chip is configured to implement the functions of the LMF network element in the embodiments of the present disclosure:
the interface 1202 is configured to perform step 21 in FIG. 2, step 31 in FIG. 3, step 32 in FIG. 3, or step 41 in FIG. 4.

For the case that the chip is configured to implement the functions of the terminal device in the embodiments of the present disclosure:
the interface 1202 is configured to perform step 55 in FIG. 5, step 61 in FIG. 6, step 62 in FIG. 6, step 71 in FIG. 7, or step 72 in FIG. 7.

For the case that the chip is configured to implement the functions of the TRP in the embodiments of the present disclosure:
the interface 1202 is configured to perform step 81 in FIG. 8, step 91 in FIG. 9, or step 92 in FIG. 9.

In some embodiments, the chip further includes a memory 1203, and the memory 1203 is configured to store necessary computer programs and data.

Those skilled in the art may also understand that the various illustrative logical blocks and steps listed in the embodiments of the present disclosure may be implemented by electronic hardware, computer software, or a combination of them. Whether such functions are implemented by hardware or software depends on the particular application and the design requirements of the entire system. Those skilled in the art may implement the functions by using various methods for each specific application, but it should not be understood that the implementation goes beyond the scope of protection of the embodiments of the present disclosure.

There is further provided a system for reporting a timing error according to embodiments of the present disclosure. The system includes a communication apparatus serving as an LMF network element, a communication apparatus serving as a terminal device, and a communication apparatus serving as a TRP in the foregoing embodiment of FIG. 10; or, the system includes a communication apparatus serving as an LMF network element, a communication apparatus serving as a terminal device, and a communication apparatus serving as a TRP in the foregoing embodiment of FIG. 11.

There is further provided a computer-readable storage medium according to the present disclosure, on which an instruction is stored. When the instruction is executed by a computer, the functions of any of the foregoing method embodiments are implemented.

There is further provided a computer program product according to the present disclosure. When the computer program product is executed by a computer, the functions of any one of the foregoing method embodiments are implemented.

According to embodiments of the present disclosure, there is provided a method and an apparatus for reporting a timing error, which can be applied to the field of communication technology.

According to a first aspect, there is provided a method for reporting a timing error according to embodiments of the present disclosure. The method is performed by a positioning management function (LMF) network element, and the method includes: receiving first indication information transmitted by a transmission end, where the first indication information is used for indicating timing error group (TEG) information of the transmission end, and the transmission end is a terminal device or a transmission and reception point (TRP).

In some embodiments, the first indication information is further used for indicating any one of following: resource information of a downlink (DL) positioning reference signal (PRS), or reference signal time difference (RSTD) measurement information.

In some embodiments, the first indication information is signal measurement information.

In some embodiments, the method further includes:
transmitting second indication information, wherein the second indication information is used for indicating a granularity factor corresponding to the TEG information.

In some embodiments, the second indication information is request location information.

In some embodiments, the method further includes:
determining the granularity factor corresponding to the TEG information according to a current positioning accuracy; or
determining the granularity factor corresponding to the TEG information according to a value range of the granularity factor corresponding to each subcarrier spacing (SCS).

In some embodiments, the method further includes:
transmitting third indication information to a terminal device, wherein the third indication information is used for indicating resource information of a downlink (DL) positioning reference signal (PRS) and TEG information of the LMF network element.

In some embodiments, the TEG information is a TEG value and/or a TEG identification.

According to a second aspect, there is provided another method for reporting a timing error according to embodiments of the present disclosure. The method is performed by a terminal device, and the method includes: transmitting first indication information to a location management function (LMF) network element, where the first indication information is used for indicating timing error group (TEG) information of the terminal device.

In some embodiments, the first indication information is further used for indicating reference signal time difference (RSTD) measurement information.

In some embodiments, the first indication information is signal measurement information.

In some embodiments, the method further includes:
receiving second indication information, where the second indication information is used for indicating a granularity factor corresponding to the TEG information.

In some embodiments, the method further includes:
receiving third indication information transmitted by the LMF network element, where the third indication information is used for indicating TEG information of the LMF network element.

In some embodiments, the method further includes:
transmitting fourth indication information to the LMF network element, where the fourth indication information is used for indicating a granularity factor corresponding to the TEG information.

In some embodiments, the method further includes:
determining the granularity factor corresponding to the TEG information according to a current positioning accuracy; or
determining the granularity factor corresponding to the TEG information according to a value range of the granularity factor corresponding to each subcarrier spacing (SCS).

In some embodiments, the fourth indication information is request location information.

In some embodiments, the TEG information is a TEG value and/or a TEG identification.

According to a third aspect, there is provided another method for reporting a timing error according to embodiments of the present disclosure. The method is performed by a transmission and reception point (TRP), and the method includes: transmitting first indication information, where the first indication information is used for indicating timing error group (TEG) information of the TRP.

In some embodiments, the first indication information is further used for indicating resource information of a downlink (DL) positioning reference signal (PRS).

In some embodiments, the first indication information is signal measurement information.

In some embodiments, the method further includes:
receiving second indication information, where the second indication information is used for indicating a granularity factor corresponding to the TEG information.

In some embodiments, the second indication information is request location information.

In some embodiments, the TEG information is a TEG value and/or a TEG identification.

According to a fourth aspect, there is provided a communication apparatus according to embodiments of the present disclosure. The communication apparatus has some or all of the functions of the location management function (LMF) network element for implementing the method according to the first aspect. For example, the functions of the communication apparatus may have the functions in some or all of the embodiments in the present disclosure, or may also have the functions for separately implementing any one of the embodiments in the present disclosure. The functions may be implemented by hardware, or may be implemented by hardware executing corresponding software. The hardware or software includes one or more units or modules corresponding to the foregoing functions.

In some embodiments, the structure of the communication apparatus may include a transceiving module and a processing module. The processing module is configured to support corresponding functions of the communication apparatus during performing the foregoing methods. The transceiving module is configured to support communication between the communication apparatus and other devices. The communication apparatus may further include a storage module. The storage module is configured to be coupled to the transceiving module and the processing module, and store computer programs and data necessary for the communication apparatus.

As an example, the processing module may be a processor, the transceiving module may be a transceiver or a communication interface, and the storage module may be a memory.

According to a fifth aspect, there is provided a communication apparatus according to embodiments of the present disclosure. The communication apparatus has some or all of the functions of the terminal device for implementing the method according to the second aspect. For example, the functions of the communication apparatus may have the functions in some or all of the embodiments in the present disclosure, or may also have the functions for separately implementing any one of the embodiments in the present disclosure. The functions may be implemented by hardware, or may be implemented by hardware executing corresponding software. The hardware or software includes one or more units or modules corresponding to the foregoing functions.

In some embodiments, the structure of the communication apparatus may include a transceiving module and a processing module. The processing module is configured to support corresponding functions of the communication apparatus during performing the foregoing methods. The transceiving module is configured to support communication between the communication apparatus and other devices. The communication apparatus may further include a storage module. The storage module is configured to be coupled to the transceiving module and the processing module, and store computer programs and data necessary for the communication apparatus.

As an example, the processing module may be a processor, the transceiving module may be a transceiver or a communication interface, and the storage module may be a memory.

According to a sixth aspect, there is provided a communication apparatus according to embodiments of the present disclosure. The communication apparatus has some or all of the functions of the transmission and reception point (TRP) for implementing the method according to the third aspect. For example, the functions of the communication apparatus may have the functions in some or all of the embodiments in the present disclosure, or may also have the functions for separately implementing any one of the embodiments in the present disclosure. The functions may be implemented by hardware, or may be implemented by hardware executing corresponding software. The hardware or software includes one or more units or modules corresponding to the foregoing functions.

In some embodiments, the structure of the communication apparatus may include a transceiving module and a processing module. The processing module is configured to support corresponding functions of the communication apparatus during performing the foregoing methods. The transceiving module is configured to support communication between the communication apparatus and other devices. The communication apparatus may further include a storage module. The storage module is configured to be coupled to the transceiving module and the processing module, and store computer programs and data necessary for the communication apparatus.

As an example, the processing module may be a processor, the transceiving module may be a transceiver or a communication interface, and the storage module may be a memory.

According to a seventh aspect, there is provided a communication apparatus according to embodiments of the present disclosure. The communication apparatus includes a processor, and when the processor invokes a computer program in a memory, the method according to the first aspect is performed.

According to an eighth aspect, there is provided a communication apparatus according to embodiments of the present disclosure. The communication apparatus includes a processor, and when the processor invokes a computer program in a memory, the method according to the second aspect is performed.

According to a ninth aspect, there is provided a communication apparatus according to embodiments of the present disclosure. The communication apparatus includes a processor, and when the processor invokes a computer program in a memory, the method according to the third aspect is performed.

According to a tenth aspect, there is provided a communication apparatus according to embodiments of the present disclosure. The communication apparatus includes a processor and a memory, and the memory stores a computer program. When the computer program is executed by the processor, the communication apparatus is enabled to perform the method according to the first aspect.

According to an eleventh aspect, there is provided a communication apparatus according to embodiments of the present disclosure. The communication apparatus includes a processor and a memory, and the memory stores a computer program. When the computer program is executed by the processor, the communication apparatus is enabled to perform the method according to the second aspect.

According to a twelfth aspect, there is provided a communication apparatus according to embodiments of the present disclosure. The communication apparatus includes a processor and a memory, and the memory stores a computer program. When the computer program is executed by the processor, the communication apparatus is enabled to perform the method according to the third aspect.

According to a thirteenth aspect, there is provided a communication apparatus according to embodiments of the present disclosure. The communication apparatus includes a processor and an interface circuit. The interface circuit is configured to receive a code instruction and transmit the code instruction to the processor, and the processor is configured to run the code instruction to enable the communication apparatus to perform the method according to the first aspect.

According to a fourteenth aspect, there is provided a communication apparatus according to embodiments of the present disclosure. The communication apparatus includes a processor and an interface circuit. The interface circuit is configured to receive a code instruction and transmit the code instruction to the processor, and the processor is configured to run the code instruction to enable the communication apparatus to perform the method according to the second aspect.

According to a fifteenth aspect, there is provided a communication apparatus according to embodiments of the present disclosure. The communication apparatus includes a processor and an interface circuit. The interface circuit is configured to receive a code instruction and transmit the code instruction to the processor, and the processor is configured to run the code instruction to enable the communication apparatus to perform the method according to the third aspect.

According to a sixteenth aspect, there is provided a system for reporting a timing error according to embodiments of the present disclosure. The system includes the communication apparatus according to the fourth aspect, the communication apparatus according to the fifth aspect, and the communication apparatus according to the sixth aspect; or, the system includes the communication apparatus according to the seventh aspect, the communication apparatus according to the eighth aspect, and the communication apparatus according to the ninth aspect; or, the system includes the communication apparatus according to the tenth aspect, the communication apparatus according to the eleventh aspect, and the communication apparatus according to the twelfth aspect; or, the system includes the communication apparatus according to the thirteenth aspect, the communication apparatus according to the fourteenth aspect, and the communication apparatus according to the fifteenth aspect.

According to a seventeenth aspect, there is provided a computer-readable storage medium according to embodiments of the present disclosure. The computer-readable storage medium is configured to store an instruction used by the location management function (LMF) network element; and when the instruction is executed, the method according to the first aspect is enabled to be implemented.

According to an eighteenth aspect, there is provided a computer-readable storage medium according to embodiments of the present disclosure. The computer-readable storage medium is configured to store an instruction used by the terminal device; and when the instruction is executed, the method according to the second aspect is enabled to be implemented.

According to a nineteenth aspect, there is provided a computer-readable storage medium according to embodiments of the present disclosure. The computer-readable storage medium is configured to store an instruction used by the transmission and reception point (TRP); and when the instruction is executed, the method according to the third aspect is enabled to be implemented.

According to a twentieth aspect, there is further provided a computer program product including a computer program according to the present disclosure. When the computer program product runs on a computer, the computer is enabled to perform the method according to the first aspect.

According to a twenty-first aspect, there is further provided a computer program product including a computer program according to the present disclosure. When the computer program product runs on a computer, the computer is enabled to perform the method according to the second aspect.

According to a twenty-second aspect, there is further provided a computer program product including a computer program according to the present disclosure. When the computer program product runs on a computer, the computer is enabled to perform the method according to the third aspect.

According to a twenty-third aspect, there is provided a chip system according to the present disclosure. The chip system includes at least one processor and an interface, for supporting a location management function (LMF) network element to implement the functions involved in the first aspect, for example, determining or processing at least one of the data or the information involved in the foregoing method. In a possible design, the chip system further includes a memory, and the memory is configured to store a computer program and data necessary for the location management function (LMF) network element. The chip system may be composed of a chip, or may include a chip and other discrete devices.

According to a twenty-fourth aspect, there is provided a chip system according to the present disclosure. The chip system includes at least one processor and an interface, for supporting a terminal device to implement the functions involved in the second aspect, for example, determining or processing at least one of data or the information involved in the foregoing method. In a possible design, the chip system further includes a memory, and the memory is configured to store a computer program and data necessary for the terminal device. The chip system may be composed of a chip, or may include a chip and other discrete devices.

According to a twenty-fifth aspect, there is provided a chip system according to the present disclosure. The chip system includes at least one processor and an interface, for supporting a transmission and reception point (TRP) to implement the functions involved in the third aspect, for example, determining or processing at least one of the data or the information involved in the foregoing method. In a possible design, the chip system further includes a memory, and the memory is configured to store a computer program and data necessary for the transmission and reception point (TRP). The chip system may be composed of a chip, or may include a chip and other discrete devices.

According to a twenty-sixth aspect, there is provided a computer program according to the present disclosure. When the computer program runs on a computer, the computer is enabled to perform the method according to the first aspect.

According to a twenty-seventh aspect, there is provided a computer program according to the present disclosure. When the computer program runs on a computer, the computer is enabled to perform the method according to the second aspect.

According to a twenty-eighth aspect, there is provided a computer program according to the present disclosure. When the computer program runs on a computer, the computer is enabled to perform the method according to the third aspect.

In the foregoing embodiments, they may be all or partially implemented by software, hardware, firmware, or any combination of them. When implemented using software, they may be all or partially implemented in the form of a computer program product. The computer program product includes one or more computer programs. When the computer program is loaded and executed on a computer, the processes or functions according to the embodiments of the present disclosure are all or partially generated. The computer may be a general-purpose computer, a special purpose computer, a computer network, or other programmable apparatus.

The computer program may be stored in a computer-readable storage medium or transmitted from a computer-readable storage medium to another computer-readable storage medium. For example, the computer program may be transmitted from a website site, a computer, a server, or a data center to another website site, another computer, another server, or another data center in a wired manner (for example, coaxial cable, optical fiber, digital subscriber line (DSL)) or a wireless manner (for example, infrared, wireless, microwave, etc.). The computer-readable storage medium may be any usable medium accessible by a computer, or a data storage device such as a server or a data center integrated with one or more usable medium. The usable medium may be a magnetic medium (for example, a floppy disk, a hard disk, or a magnetic tape), an optical medium (for example, a high-density digital video disc (DVD)), or a semiconductor medium (for example, a solid-stated disk (SSD)), etc.

Those of ordinary skills in the art may understand that the first, second and other numerical symbols involved in the present disclosure are for distinguishing for the sake of convenience in description, and are not used to limit the scope of the embodiments of the present disclosure, and also represent the sequence.

At least one in the present disclosure may also be described as one or more, and more than one may be two, three, four or more, which is not limited in the present disclosure. In the embodiments of the present disclosure, for a kind of technical features, the technical features in this kind of technical features are distinguished by “first”, “second”, “third”, “A”, “B”, “C”, “D”, etc. The technical features described in “first”, “second”, “third”, “A”, “B”, “C” and “D” have no sequential order or size order.

The corresponding relationship shown in each table in the present disclosure may be configured, or may be predefined. The value of the information in each table is an example, and may be configured as other values, which is not limited in the present disclosure. When the corresponding relationship between the information and each parameter is configured, there is no need to configure all corresponding relationships shown in each table. For example, in the table in the present disclosure, the corresponding relationships shown in certain rows may also not be configured. For another example, appropriate deformation adjustment may be performed based on the above table, such as, splitting, merging, or the like. The name of the parameter shown in the title of each table may also be other names that may be understood by the communication apparatus, and the value or the representation manner of the parameter may also be other values or representation manners that may be understood by the communication apparatus. When the foregoing tables are implemented, other data structures may also be used; for example, an array, a queue, a container, a stack, a linear table, a pointer, a linked list, a tree, a graph, a structure, a class, a stack, or a hash table may be used.

Predefining in the present disclosure may be understood as defining, pre-defining, storing, pre-storing, pre-negotiating, pre-configuring, curing, or pre-firing.

Those of ordinary skills in the art may be aware that units and algorithm steps in the examples described in connection with the embodiments disclosed here can be implemented by electronic hardware, or a combination of computer software and electronic hardware. Whether the functions are performed by hardware or software depends on specific applications and design constraint conditions of the technical solutions. Those skilled in the art may use different methods to implement the described functions for each specific application, but it should not be considered that the implementation goes beyond the scope of the present disclosure.

It may be clearly understood by those skilled in the art that, for the convenience and brevity of description, the specific working process of the described system, apparatus, and units may refer to the corresponding process in the foregoing method embodiments, and details are not described here again.

The foregoing is a specific implementation of the present disclosure, but the scope of protection of the present disclosure is not limited to this. Any of those skilled in the art familiar with the art may easily conceive of change or replacement within the technical scope disclosed in the present disclosure, which should be covered within the scope of protection of the present disclosure. Therefore, the protection scope of the present disclosure shall be subject to the protection scope of the claims.

1. A method for reporting a timing error, performed by a location management function (LMF) network element, and the method comprising:
receiving first indication information transmitted by a transmission end, wherein the first indication information indicates timing error group (TEG) information of the transmission end, and the transmission end is a terminal device or a transmission and reception point (TRP).

2. The method according to claim 1, wherein the first indication information further indicates any one of: resource information of a downlink (DL) positioning reference signal (PRS), or reference signal time difference (RSTD) measurement information.

3. The method according to claim 1, wherein the first indication information is signal measurement information.

4. The method according to claim 1, further comprising at least one of:
transmitting second indication information, wherein the second indication information indicates a granularity factor corresponding to the TEG information; or
transmitting third indication information to the terminal device, wherein the third indication information indicates resource information of a downlink (DL) positioning reference signal (PRS) and TEG information of the LMF network element.

5. The method according to claim 4, wherein the second indication information is request location information.

6. The method according to claim 5, further comprising at least one of:
determining the granularity factor corresponding to the TEG information according to a current positioning accuracy; or
determining the granularity factor corresponding to the TEG information according to a value range of the granularity factor corresponding to each subcarrier spacing (SCS).

7. (canceled)

8. The method according to claim 1, wherein the TEG information is at least one of a TEG value or a TEG identification.

9. A method for reporting a timing error, performed by a terminal device, and the method comprising:
transmitting first indication information to a location management function (LMF) network element, wherein the first indication information indicates timing error group (TEG) information of the terminal device.

10. The method according to claim 9, wherein the first indication information further indicates reference signal time difference (RSTD) measurement information.

11. The method according to claim 9, wherein the first indication information is signal measurement information.

12. The method according to claim 9, further comprising at least one of:
receiving second indication information, wherein the second indication information indicates a granularity factor corresponding to the TEG information; or
receiving third indication information transmitted by the LMF network element, wherein the third indication information indicates TEG information of the LMF network element.

13. (canceled)

14. The method according to claim 12, further comprising:
transmitting fourth indication information to the LMF network element, wherein the fourth indication information indicates a granularity factor corresponding to the TEG information.

15. The method according to claim 14, further comprising at least one of:
determining the granularity factor corresponding to the TEG information according to a current positioning accuracy; or
determining the granularity factor corresponding to the TEG information according to a value range of the granularity factor corresponding to each subcarrier spacing (SCS).

16. The method according to claim 14, wherein the fourth indication information is request location information.

17. The method according to claim 9, wherein the TEG information is at least one of a TEG value and/or or a TEG identification.

18. A method for reporting a timing error, performed by a transmission and reception point (TRP), and the method comprising:
transmitting first indication information, wherein the first indication information indicates timing error group (TEG) information of the TRP.

19. The method according to claim 18, wherein the first indication information further indicates resource information of a downlink (DL) positioning reference signal (PRS).

20. The method according to claim 18, wherein the first indication information is signal measurement information.

21. The method according to claim 18, further comprising:
receiving second indication information, wherein the second indication information indicates a granularity factor corresponding to the TEG information,
wherein the second indication information is request location information.

22. (canceled)

23. The method according to claim 18, wherein the TEG information is at least one of a TEG value and/or or a TEG identification.

24.-35. (canceled)
